(19) United States
(12) Patent Application Publication
(10) Pub. No.: US 2022/0391835 A1
(43) Pub. Date: Dec. 8, 2022

(54) Method and Device for Monitoring Delivery Process, Server and Method Therein

(71) Applicant: Telefonaktiebolaget LM Ericsson (PUBL), Stockholm (SE)

(72) Inventor: Peng LV, Nanjing, Jiangsu (CN)

(21) Appl. No.: 17/776,087

(22) PCT Filed: Nov. 6, 2020
(86) PCT No.: PCT/CN2020/127098

§ 371 Date: May 11, 2022

(30) Foreign Application Priority Data
Nov. 15, 2019 (CN) PCT/CN2019/118794

(51) Int. Cl. G06Q 10/08

(52) U.S. Cl. CPC G06Q 10/0833

(57) ABSTRACT

A device (100) for monitoring a delivery process of a package. The device (100) includes: at least one sensor (110) configured to obtain condition data associated with the package during the delivery process; a communication interface (120); and a processor (130) configured to receive the condition data from the at least one sensor (110) and to transmit a report based on the condition data to a server (400, 500) via the communication interface (120).

### TECHNICAL FIELD

The present disclosure relates to the field of logistics, and more particularly, to a method and a device for monitoring a delivery process, a server and a method therein.

### BACKGROUND

This section introduces aspects that may facilitate better understanding of the present disclosure. Accordingly, the statements of this section are to be read in this light and are not to be understood as admissions about what is in the prior art or what is not in the prior art.

An enormous number of packages are being created every day, mainly driven by the booming online business. However, there is a common pain point in the logistics industry that packages, or goods in the packages, are unexpectedly damaged due to improper treatment such as brutal delivery behaviors during loading/unloading and transportation, or inappropriate storage conditions.

In many countries, governments have set up regulations to stop brutal delivery behaviors. An existing method for monitoring a brutal delivery behavior is to use video cameras to capture a video of an operator during a loading/unloading or transportation process, and use Artificial Intelligence (AI) based image recognition techniques to process the video so as to identify a brutal behavior. However, currently the image recognition techniques cannot identify brutal behaviors reliably and accurately. For example, a success rate of identifying brutal behaviors is low due to the difficulty in recognizing dynamic actions. Further, it would be difficult to deploy video cameras to provide 360-degree monitoring in order to determine whether there is any brutal delivery behavior. Moreover, the video-based method cannot provide end-to-end monitoring of the entire delivery process.

In addition, inappropriate or unsatisfying environment conditions around the packages during the delivery process may also cause some unexpected damage to the packages to be delivered.

### SUMMARY

It is an object of the present disclosure to provide a method and a device for monitoring a delivery process, a server and a method therein, capable of achieving a reliable, efficient, end-to-end monitoring of a delivery process.

According to a first aspect of the present disclosure, a device for monitoring a delivery process of a package is provided. The device includes: at least one sensor configured to obtain condition data associated with the package during the delivery process; a communication interface; and a processor configured to receive the condition data from the at least one sensor and to transmit a report based on the condition data to a server via the communication interface.

In an embodiment, the processor may be configured to transmit the report in response to determining that the condition data satisfies a predefined criterion.

In an embodiment, the device may further include a positioning circuit. The processor may be further configured to: activate the positioning circuit to obtain a position of the package in response to determining that the condition data satisfies the predefined criterion; and receive from the positioning circuit the position of the package. The position of the package may be included in the report.

In an embodiment, the device may further include a memory configured to store the condition data. The processor may be further configured to detect an abnormal event by analyzing a pattern of the stored condition data over time. The abnormal event may be indicated in the report.

In an embodiment, the at least one sensor may include a vibration sensor configured to measure, as the condition data, an amplitude of a vibration the package experiences during the delivery process. The operation of determining that the condition data satisfies the predefined criterion may include determining that the amplitude is larger than an amplitude threshold.

In an embodiment, the at least one sensor may include a vibration sensor configured to measure, as the condition data, an amplitude and a direction of a vibration the package experiences during the delivery process. The operation of determining that the condition data satisfies the predefined criterion may include determining that the amplitude of the vibration in a predefined direction is larger than an amplitude threshold.

In an embodiment, the amplitude threshold can be set or adjusted depending on a type of goods contained in the package and/or a Quality of Service (QoS) requirement of the delivery process.

In an embodiment, the at least one sensor may include a temperature sensor configured to measure, as the condition data, an environmental temperature the package experiences during the delivery process. The operation of determining that the condition data satisfies the predefined criterion may include determining that the environmental temperature is higher than an upper temperature threshold or lower than a lower temperature threshold.

In an embodiment, the upper temperature threshold and/or the lower temperature threshold may be set or adjusted depending on a type of goods contained in the package and/or a QoS requirement of the delivery process.

In an embodiment, the at least one sensor may include a humidity sensor configured to measure, as the condition data, an environmental humidity the package experiences during the delivery process. The operation of determining that the condition data satisfies the predefined criterion may include determining that the environmental humidity is higher than an upper humidity threshold or lower than a lower humidity threshold.

In an embodiment, the upper humidity threshold and/or the lower humidity threshold may be set or adjusted depending on a type of goods contained in the package and/or a QoS requirement of the delivery process.

In an embodiment, the at least one sensor may include a pressure sensor configured to measure, as the condition data, a pressure applied to the package during the delivery process. The operation of determining that the condition data satisfies the predefined criterion may include determining that the pressure is higher than a pressure threshold.

In an embodiment, the pressure threshold may be set or adjusted depending on a type of goods contained in the package and/or a QoS requirement of the delivery process.

In an embodiment, the processor may be further configured to transmit a warning message to a communication device of an operator associated with the delivery process via the communication interface in response to determining that the condition data satisfies the predefined criterion.

In an embodiment, the communication interface may include one or more short-range communication interfaces and/or one or more long-range communication interfaces.

In an embodiment, the device may be attached to the package.

According to a second aspect of the present disclosure, a method for monitoring a delivery process of a package is provided. The method includes: obtaining condition data associated with the package during the delivery process; and transmitting a report based on the condition data to a server.

In an embodiment, the report can be transmitted in response to determining that the condition data satisfies a predefined criterion.

In an embodiment, the method may further include: obtaining a position of the package in response to determining that the condition data satisfies the predefined criterion data. The position of the package may be included in the report.

In an embodiment, the method may further include: storing the condition data; and detecting an abnormal event by analyzing a pattern of the stored condition data over time. The abnormal event may be indicated in the report.

In an embodiment, the operation of obtaining may include measuring, as the condition data, an amplitude of a vibration the package experiences during the delivery process, and the operation of determining that the condition data satisfies the predefined criterion may include determining that the amplitude is larger than an amplitude threshold.

In an embodiment, the operation of obtaining may include measuring, as the condition data, an amplitude and a direction of a vibration the package experiences during the delivery process, and the operation of determining that the condition data satisfies the predefined criterion may include determining that the amplitude of the vibration in a predefined direction is larger than an amplitude threshold.

In an embodiment, the amplitude threshold may be set or adjusted depending on a type of goods contained in the package and/or a QoS requirement of the delivery process.

In an embodiment, the operation of obtaining may include measuring, as the condition data, an environmental temperature the package experiences during the delivery process, and the operation of determining that the condition data satisfies the predefined criterion may include determining that the environmental temperature is higher than an upper temperature threshold or lower than a lower temperature threshold.

In an embodiment, the upper temperature threshold and/or the lower temperature threshold may be set or adjusted depending on a type of goods contained in the package and/or a QoS requirement of the delivery process.

In an embodiment, the operation of obtaining may include measuring, as the condition data, an environmental humidity the package experiences during the delivery process, and the operation of determining that the condition data satisfies the predefined criterion may include determining that the environmental humidity is higher than an upper humidity threshold or lower than a lower humidity threshold.

In an embodiment, the upper humidity threshold and/or the lower humidity threshold may be set or adjusted depending on a type of goods contained in the package and/or a QoS requirement of the delivery process.

In an embodiment, the operation of obtaining may include measuring, as the condition data, a pressure applied to the package during the delivery process, and the operation of determining that the condition data satisfies the predefined criterion may include determining that the pressure is higher than a pressure threshold.

In an embodiment, the pressure threshold may be set or adjusted depending on a type of goods contained in the package and/or a QoS requirement of the delivery process.

In an embodiment, the method may further include: transmitting a warning message to a communication device of an operator associated with the delivery process.

According to a third aspect of the present disclosure, a method in a server is provided. The method includes: receiving from a device a report obtained from condition data associated with a package during a delivery process; and issuing a warning based on the report.

In an embodiment, the report may indicate the condition data and a position of the package when the condition data is obtained.

In an embodiment, the report may further indicate an abnormal event.

In an embodiment, the method may further include: storing the condition data; and detecting an abnormal event by analyzing a pattern of the stored condition data over time.

In an embodiment, the condition data may include an amplitude of a vibration the package experiences during the delivery process, an environmental temperature the package experiences during the delivery process, an environmental humidity the package experiences during the delivery process, and/or a pressure applied to the package during the delivery process.

In an embodiment, the operation of issuing may include sending the warning to one or more of: a sender of the package, a recipient of the package, or an operator associated with the delivery process.

According to a fourth aspect of the present disclosure, a server is provided. The server includes a communication interface, a processor and a memory. The memory stores instructions executable by the processor whereby the server is operative to perform the method according to the above third aspect.

According to a fifth aspect of the present disclosure, a computer readable storage medium is provided. The computer readable storage medium has computer program instructions stored thereon. The computer program instructions, when executed by a processor in a server, cause the server to perform the method according to the above third aspect.

With the embodiments of the present disclosure, a sensor obtains condition data associated with a package during a delivery process and transmits the condition data to a processor, which then transmits a report based on the condition data to a server. In this way, the condition data, including e.g., a vibration amplitude, temperature, humidity or pressure, associated with the package can be monitored reliably and efficiently during the delivery process, such that the report based on the condition data can be transmitted to the server, which for example can then issue an alarm in response to an abnormal event derived from the report.

### BRIEF DESCRIPTION OF THE DRAWINGS

The above and other objects, features and advantages will be more apparent from the following description of embodiments with reference to the figures, in which:

FIG. 1 is a block diagram of a device for monitoring a delivery process according to an embodiment of the present disclosure

FIG. 2 is a flowchart illustrating a method for monitoring a delivery process according to an embodiment of the present disclosure;

FIG. 3 is a flowchart illustrating a method in a server according to an embodiment of the present disclosure;

FIG. 4 is a block diagram of a server according to an embodiment of the present disclosure; and

FIG. 5 is a block diagram of a server according to another embodiment of the present disclosure.

### DETAILED DESCRIPTION

In the following, references in the specification to “one embodiment”, “an embodiment”, “an example embodiment” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms. The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

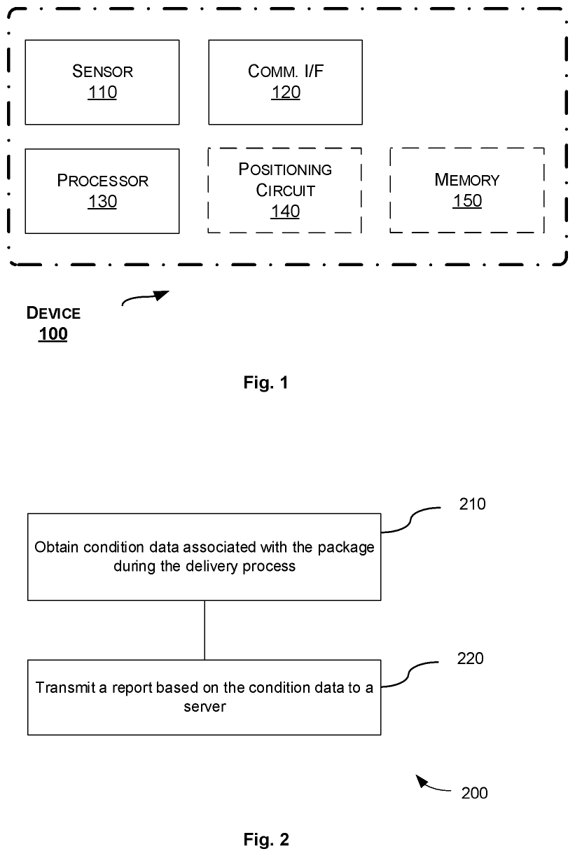

FIG. 1 is a block diagram of a device 100 for monitoring a delivery process of a package according to an embodiment of the present disclosure. The device 100 can e.g., be implemented by or with an Internet of Things (IoT) modem and/or be implemented as a single chip. For example, the device 100 can be attached to the package. The delivery process may include e.g., loading/unloading, transportation and/or storage.

As shown in FIG. 1, the device 100 includes at least one sensor 110 configured to obtain condition data associated with the package during the delivery process.

The device 100 further includes a communication interface 120, which may include one or more short-range communication interfaces, such as Wireless Fidelity (WiFi), Bluetooth, Zigbee, or Near Field Communication (NFC), and/or one or more long-range communication interfaces, such as cellular (e.g., 2G (the 2^{nd} Generation), 3G (the 3^{rd} Generation), 4G (the 4^{th} Generation), or 5G (the 5^{th} Generation)) or satellite communication interfaces (in particular, Long Term Evolution (LTE) Cat. M1 or Narrow Band-Internet of Things (NB-IoT)).

The device 100 further includes a processor 130 configured to receive the condition data from the at least one sensor 110 and to transmit a report based on the condition data to a server, e.g., a cloud server or an application server, via the communication interface 120. In an example, the processor 130 can be configured to transmit the report in response to determining that the condition data satisfies a predefined criterion.

For example, the at least one sensor 110 may include a vibration sensor configured to measure, as the condition data, an amplitude of a vibration the package experiences during the delivery process. The processor 130 can determine that the condition data satisfies the predefined criterion when determining that the amplitude is larger than an amplitude threshold.

In another example, the at least one sensor 110 may include a vibration sensor configured to measure, as the condition data, an amplitude and a direction of a vibration the package experiences during the delivery process. The processor 130 can determine that the condition data satisfies the predefined criterion when determining that the amplitude of the vibration in a predefined direction is larger than an amplitude threshold.

Alternatively or additionally, the at least one sensor 110 may include a temperature sensor configured to measure, as the condition data, an environmental temperature the package experiences during the delivery process. The processor 130 can determine that the condition data satisfies the predefined criterion when determining that the environmental temperature is higher than an upper temperature threshold or lower than a lower temperature threshold.

Alternatively or additionally, the at least one sensor 110 may include a humidity sensor configured to measure, as the condition data, an environmental humidity the package experiences during the delivery process. The processor 130 can determine that the condition data satisfies the predefined criterion when determining that the environmental humidity is higher than an upper humidity threshold or lower than a lower humidity threshold.

Alternatively or additionally, the at least one sensor 110 may include a pressure sensor configured to measure, as the condition data, a pressure applied to the package during the delivery process. The processor 130 can determine that the condition data satisfies the predefined criterion comprises determining that the pressure is higher than a pressure threshold.

Please note that the at least one sensor 110 may include some other sensor(s) according to delivery requirements so as to obtain expected delivery quality.

In an example, the amplitude threshold, the upper temperature threshold, the lower temperature threshold, the upper humidity threshold, the lower humidity threshold, and/or the pressure threshold as described above can be predefined/set or adjusted depending on a type of goods contained in the package and/or a Quality of Service (QoS) requirement of the delivery process. As an example, for a package containing fragile goods, a low amplitude threshold and/or a low pressure threshold can be set. For a package containing goods that need to be transported or stored above or below a particular temperature and/or humidity, or in a particular temperature and/or humidity range, the upper and/or lower temperature thresholds and/or the upper and/or lower humidity thresholds can be set accordingly. When a sender or a recipient of the package subscribes to a delivery service having a high QoS requirement, e.g., when the package is of high importance, one or more of the above thresholds can be set according to the QoS requirement, e.g., a low amplitude threshold and/or a low pressure threshold can be set in order to meet the QoS requirement. In addition, in some embodiments, the condition data can be obtained in real-time. With such real-time condition data, various thresholds as mentioned above in association with different sensors can be dynamically adjusted.

Optionally, in an example, the device 100 can further include a positioning circuit 140, e.g., a Global Positioning System (GPS) receiver. The processor 130 can be further configured to: activate the positioning circuit 140 to obtain a position of the package, e.g., in response to determining that the condition data satisfies the predefined criterion; and receive from the positioning circuit 140 the position of the package. In this case, the position of the package is included in the report. Accordingly, the positioning circuit 140 can be activated only when e.g., a high vibration amplitude, a high (or low) temperature or humidity, and/or a high pressure is detected by the sensor 110.

Optionally, in an example, the device 100 can further include a memory 150 configured to store the condition data. The processor 130 can be further configured to detect an abnormal event by analyzing a pattern of the stored condition data over time. For example, when a pattern of the stored vibration amplitude measured over a time period shows that the vibration amplitude exceeds the amplitude threshold for at least a number of times, an abnormal event indicating a brutal delivery behavior may be detected. Here the time period, the amplitude threshold, and the number of times can be configurable e.g., depending on the type of goods contained in the package and/or the QoS requirement of the delivery process. The abnormal event can be indicated in the report.

In an example, the processor 130 can be further configured to transmit a warning message to a communication device of an operator associated with the delivery process via the communication interface 120. For example, the warning message can be transmitted, e.g., via a Bluetooth communication interface, to a user device (e.g., a smart phone) of a driver during a vehicle transportation in response to determining that the condition data satisfies a predefined criterion.

In an example, the report can be an instruction to record the condition data and/or the abnormal event, and/or to issue a warning accordingly.

FIG. 2 is a flowchart illustrating a method 200 for monitoring a delivery process of a package according to an embodiment of the present disclosure. The method 200 can be performed by the device 100 as described above in connection with FIG. 1.

At block 210, condition data associated with the package is obtained, e.g., by at least one sensor, during the delivery process.

At block 220, a report based on the condition data is transmitted to a server (e.g., a cloud server), e.g., via a communication interface.

In an example, the report can be transmitted in response to determining that the condition data satisfies a predefined criterion.

In an example, in the block 210, an amplitude of a vibration the package experiences during the delivery process can be measured, e.g., by a vibration sensor, as the condition data. It can be determined that the condition data satisfies the predefined criterion when determining that the amplitude is larger than an amplitude threshold.

In another example, in the block 210, an amplitude and a direction of a vibration the package experiences during the delivery process can be measured, e.g., by a vibration sensor, as the condition data. It can be determined that the condition data satisfies the predefined criterion when determining that the amplitude of the vibration in a predefined direction is larger than an amplitude threshold.

Alternatively or additionally, in the block 210, an environmental temperature the package experiences during the delivery process can be measured, e.g., by a temperature sensor, as the condition data. It can be determined that the condition data satisfies the predefined criterion when determining that the environmental temperature is higher than an upper temperature threshold or lower than a lower temperature threshold.

Alternatively or additionally, in the block 210, an environmental humidity the package experiences during the delivery process can be measured, e.g., by a humidity sensor, as the condition data. It can be determined that the condition data satisfies the predefined criterion when determining that the environmental humidity is higher than an upper humidity threshold or lower than a lower humidity threshold.

Alternatively or additionally, in the block 210, a pressure applied to the package during the delivery process can be measured, e.g., by a pressure sensor, as the condition data. It can be determined that the condition data satisfies the predefined criterion when determining that the pressure is higher than a pressure threshold.

In an example, the amplitude threshold, the upper temperature threshold, the lower temperature threshold, the upper humidity threshold, the lower humidity threshold, and/or the pressure threshold as described above can be set or adjusted depending on a type of goods contained in the package and/or a QoS requirement of the delivery process, as discussed above in connection with the device 100.

In an example, a position of the package can be obtained, e.g., by using a GPS receiver, in response to determining that the condition data satisfies the predefined criterion data. The position of the package can be included in the report.

In an example, the condition data can be stored, and an abnormal event can be detected by analyzing a pattern of the stored condition data over time. The abnormal event can be indicated in the report.

In an example, a warning message can be transmitted, e.g., via a short-range communication interface, to a communication device of an operator associated with the delivery process in response to determining that the condition data satisfies the predefined criterion.

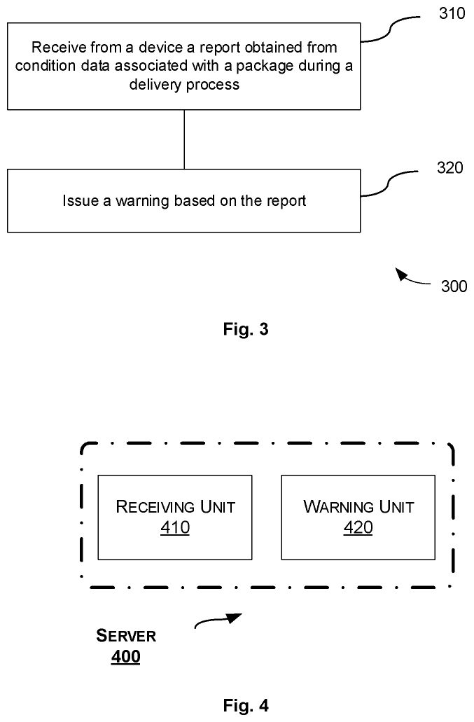

FIG. 3 is a flowchart illustrating a method 300 according to an embodiment of the present disclosure. The method 300 can be performed at a server, e.g., a cloud server or an application server.

At block 310, a report is received from a device, e.g., the device 100 as described above in connection with FIG. 1. The report is obtained from condition data associated with a package during a delivery process. Here, the delivery process may include e.g., loading/unloading, transportation and/or storage.

In an example, the condition data may include e.g., an amplitude of a vibration the package experiences during the delivery process, an environmental temperature the package experiences during the delivery process, an environmental humidity the package experiences during the delivery process, and/or a pressure applied to the package during the delivery process.

In an example, the report can indicate the condition data and a position of the package when the condition data is obtained.

In an example, the report can further indicate an abnormal event. Alternatively, the condition data can be stored, and an abnormal event can be detected by analyzing a pattern of the stored condition data over time. For example, when a pattern of the stored vibration amplitudes over a time period shows that the vibration amplitudes are continuously higher than an amplitude threshold, an abnormal event indicating a brutal delivery behavior may be detected.

In an example, the report can be an instruction to record the condition data and/or the abnormal event, and/or to issue a warning accordingly.

At block 320, a warning is issued based on the report. In particular, the warning can be sent to one or more of: a sender of the package, a recipient of the package, or an operator associated with the delivery process. Here, the server may have stored or can retrieve contact information of the sender, recipient and the operator. When e.g., an abnormal event is indicated in the report or detected by the server, a warning can be sent to an operator responsible for loading/unloading, transportation or storage of the package, such that the event can be handled properly and timely.

Correspondingly to the method 300 as described above, a server, e.g., a cloud server, is provided. FIG. 4 is a block diagram of a server 400 according to an embodiment of the present disclosure.

As shown in FIG. 4, the server 400 includes a receiving unit 410 configured to receive from a device a report obtained from condition data associated with a package during a delivery process. The server 400 further includes a warning unit 420 configured to issue a warning based on the report.

In an embodiment, the report may indicate the condition data and a position of the package when the condition data is obtained.

In an embodiment, the report may further indicate an abnormal event.

In an embodiment, the server 400 may further include: a memory configured to store the condition data; and a detecting unit configured to detect an abnormal event by analyzing a pattern of the stored condition data over time.

In an embodiment, the condition data may include an amplitude of a vibration the package experiences during the delivery process, an environmental temperature the package experiences during the delivery process, an environmental humidity the package experiences during the delivery process, and/or a pressure applied to the package during the delivery process.

In an embodiment, the warning unit can be configured to send the warning to one or more of: a sender of the package, a recipient of the package, or an operator associated with the delivery process.

The units 410˜420 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 3.

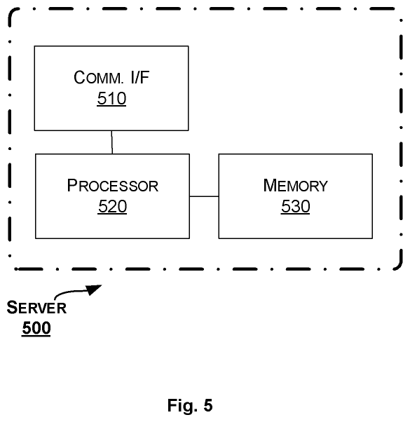

FIG. 5 is a block diagram of a server 500 according to another embodiment of the present disclosure.

The server 500 includes a communication interface 510, a processor 520 and a memory 530. For example, the memory 530 can contain instructions executable by the processor 520 whereby the server 500 is operative to perform the actions, e.g., of the procedure described earlier in conjunction with FIG. 3. Particularly, the memory 530 can contain instructions executable by the processor 520 whereby the server 500 is operative to: receive from a device a report obtained from condition data associated with a package during a delivery process; and issue a warning based on the report.

In an embodiment, the report may indicate the condition data and a position of the package when the condition data is obtained.

In an embodiment, the report may further indicate an abnormal event.

In an embodiment, the memory 530 can further contain instructions executable by the processor 520 whereby the server 500 is operative to: store the condition data; and detect an abnormal event by analyzing a pattern of the stored condition data over time.

In an embodiment, the condition data may include an amplitude of a vibration the package experiences during the delivery process, an environmental temperature the package experiences during the delivery process, an environmental humidity the package experiences during the delivery process, and/or a pressure applied to the package during the delivery process.

In an embodiment, the operation of issuing may include sending the warning to one or more of: a sender of the package, a recipient of the package, or an operator associated with the delivery process.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 130 causes the device 100 to perform the actions, e.g., of the procedure described earlier in conjunction with FIG. 2, or code/computer readable instructions, which when executed by the processor 520 causes the server 500 to perform the actions, e.g., of the procedure described earlier in conjunction with FIG. 3.

The computer program product may be configured as a computer program code structured in computer program modules. The computer program modules could essentially perform the actions of the flow illustrated in FIG. 2 or 3.

The processor may be a single CPU (Central Processing Unit), but could also comprise two or more processing units. For example, the processor may include general purpose microprocessors; instruction set processors and/or related chips sets and/or special purpose microprocessors such as Application Specific Integrated Circuits (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random-Access Memory (RAM), a Read-Only Memory (ROM), or an EEPROM, and the computer program modules described above could in alternative embodiments be distributed on different computer program products in the form of memories.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

1. A device for monitoring a delivery process of a package, comprising:
at least one sensor configured to obtain condition data associated with the package during the delivery process;
a communication interface; and
a processor configured to receive the condition data from the at least one sensor and to transmit a report based on the condition data to a server via the communication interface.

2. The device of claim 1, wherein the processor is configured to transmit the report in response to determining that the condition data satisfies a predefined criterion.

3. The device of claim 2, further comprising:
a positioning circuit,
wherein the processor is further configured to:
activate the positioning circuit to obtain a position of the package in response to determining that the condition data satisfies the predefined criterion; and
receive from the positioning circuit the position of the package, and
wherein the position of the package is included in the report.

4. The device of claim 2, further comprising:
a memory configured to store the condition data,
wherein the processor is further configured to detect an abnormal event by analyzing a pattern of the stored condition data over time, and wherein the abnormal event is indicated in the report.

5. The device of claim 2, wherein the at least one sensor comprises a vibration sensor configured to measure, as the condition data, an amplitude of a vibration the package experiences during the delivery process, and wherein said determining that the condition data satisfies the predefined criterion comprises determining that the amplitude is larger than an amplitude threshold.

6. The device of claim 2, wherein the at least one sensor comprises a vibration sensor configured to measure, as the condition data, an amplitude and a direction of a vibration the package experiences during the delivery process, and wherein said determining that the condition data satisfies the predefined criterion comprises determining that the amplitude of the vibration in a predefined direction is larger than an amplitude threshold.

7. The device of claim 5, wherein the amplitude threshold is set or adjusted depending on a type of goods contained in the package and/or a Quality of Service, QoS, requirement of the delivery process.

8. The device of claim 2, wherein the at least one sensor comprises a temperature sensor configured to measure, as the condition data, an environmental temperature the package experiences during the delivery process, and wherein said determining that the condition data satisfies the predefined criterion comprises determining that the environmental temperature is higher than an upper temperature threshold or lower than a lower temperature threshold.

9. The device of claim 8, wherein the upper temperature threshold and/or the lower temperature threshold is set or adjusted depending on a type of goods contained in the package and/or a Quality of Service, QoS, requirement of the delivery process.

10. The device of claim 2, wherein the at least one sensor comprises a humidity sensor configured to measure, as the condition data, an environmental humidity the package experiences during the delivery process, and wherein said determining that the condition data satisfies the predefined criterion comprises determining that the environmental humidity is higher than an upper humidity threshold or lower than a lower humidity threshold.

11. The device of claim 10, wherein the upper humidity threshold and/or the lower humidity threshold is set or adjusted depending on a type of goods contained in the package and/or a Quality of Service, QoS, requirement of the delivery process.

12. The device of claim 2, wherein the at least one sensor comprises a pressure sensor configured to measure, as the condition data, a pressure applied to the package during the delivery process, and wherein said determining that the condition data satisfies the predefined criterion comprises determining that the pressure is higher than a pressure threshold.

13. The device of claim 12, wherein the pressure threshold is set or adjusted depending on a type of goods contained in the package and/or a Quality of Service, QoS, requirement of the delivery process.

14. The device of claim 2, wherein the processor is further configured to transmit a warning message to a communication device of an operator associated with the delivery process via the communication interface in response to determining that the condition data satisfies the predefined criterion.

15. The device of claim 1, wherein the communication interface comprises one or more short-range communication interfaces and/or one or more long-range communication interfaces.

16. The device of claim 1, wherein the device is attached to the package.

17. A method for monitoring a delivery process of a package, comprising:
obtaining condition data associated with the package during the delivery process; and
transmitting a report based on the condition data to a server.

18. The method of claim 17, wherein the report is transmitted in response to determining that the condition data satisfies a predefined criterion.

19. The method of claim 18, further comprising:
obtaining a position of the package in response to determining that the condition data satisfies the predefined criterion data,
wherein the position of the package is included in the report.

20.-30. (canceled)

31. A method in a server, comprising:
receiving from a device a report obtained from condition data associated with a package during a delivery process; and
issuing a warning based on the report.

32.-38. (canceled)
